(19) United States
(12) Patent Application Publication
(10) Pub. No.: US 2025/0002758 A1
(43) Pub. Date: Jan. 2, 2025

(54) SINGLE-LAYER ADHESIVE FILM AND RELATED ARTICLE

(71) Applicant: 3M INNOVATIVE PROPERTIES COMPANY, St. Paul, MN (US)

(72) Inventors: Shingo Amari, Sagamihara-shi (JP); Sayaka Kado, Yamato City (JP); Eric W. Nelson, Stillwater, MN (US); Andrew T. Swanson, St. Paul, MN (US)

(21) Appl. No.: 18/684,433

(22) PCT Filed: Aug. 18, 2022
(86) PCT No.: PCT/IB2022/057761

§ 371 Date: Feb. 16, 2024

Related U.S. Application Data
(60) Provisional application No. 63/234,870, filed on Aug. 19, 2021.

(51) Int. Cl. C09J 7/38; C09J 7/10; C09J 11/06

(52) U.S. Cl. CPC C09J 7/385; C09J 7/10; C09J 11/06; C09J 2301/408; C09J 2301/416

(57) ABSTRACT

An adhesive film includes a single adhesive layer. The single adhesive layer includes an acrylic polymer and an ultraviolet light absorber capable of absorbing in a wavelength range between 320 nanometers and 390 nanometers. The single adhesive layer has first and second opposing major surfaces and a core between the first and second opposing major surfaces. The first and second opposing major surfaces each has an elastic modulus that is higher than an elastic modulus of the core, or the first and second opposing major surfaces each has an elastic modulus that is lower than an elastic modulus of the core. The article can be, for example, an automotive display that includes the adhesive film.

### BACKGROUND

Pressure-sensitive adhesives (often referred to as PSAs) are useful for a variety of purposes. Such adhesives can be produced using methods including coating an adhesive polymer composition in solvent or an emulsion onto a support and subsequently removing the solvent or water. Solvent-free adhesives and tapes can be produced by hot melt processes or by irradiating an adhesive composition including one or more acrylic monomers and a photoinitiator using ultraviolet light.

Some ultraviolet light-cured adhesive sheets having different properties on opposite surfaces have been described in U.S. Pat. No. 9,359,528 (Yoon et al.) and U.S. Pat. No. 9,405,049 (Yoon et al.); U.S. Pat. Appl. Pub. Nos. 2008/0220251 (Takaki), 2008/0227909 (Yoda et al.), and 2015/0166841 (Ueda et al.); and Japanese Patent Application publication number 2006-299053, published Nov. 2, 2006.

### SUMMARY

The present disclosure provides an adhesive film having multi-layer-like properties provided with a single adhesive layer. The first and second opposing major surfaces of the single adhesive layer each has a modulus that is higher than a modulus of the core, or the first and second opposing major surfaces of the adhesive film each has a modulus that is lower than a modulus of the core.

In one aspect, the present disclosure provides an adhesive film that includes a single adhesive layer. The single adhesive layer includes an acrylic polymer and an ultraviolet light absorber capable of absorbing in a wavelength range between 320 nanometers and 390 nanometers. The single adhesive layer has first and second opposing major surfaces and a core between the first and second opposing major surfaces. The first and second opposing major surfaces each has an elastic modulus that is higher than an elastic modulus of the core, or the first and second opposing major surfaces each has an elastic modulus that is lower than an elastic modulus of the core.

In another aspect, the present disclosure provides an article including the adhesive film. The article can include a first substrate and the adhesive film. The adhesive film is bonded to a surface of the first substrate. In some embodiments, the article includes a second substrate in which the adhesive film is bonded to a surface of the second substrate.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5).

The terms “first” and “second” are used in this disclosure in their relative sense only. It will be understood that, unless otherwise noted, those terms are used merely as a matter of convenience in the description of one or more of the embodiments.

The term “acrylic” refers to both acrylic and methacrylic polymers, oligomers, and monomers.

The term “(meth)acrylate” with respect to a monomer, oligomer, or polymer means a vinyl-functional alkyl ester formed as the reaction product of an alcohol with an acrylic or a methacrylic acid. “(Meth)acrylate” includes, separately and collectively, methacrylate and acrylate.

“Alkyl group” and the prefix “alk-” are inclusive of both straight chain and branched chain groups having up to 30 carbons (in some embodiments, up to 20, 15, 12, 10, 8, 7, 6, or 5 carbons) unless otherwise specified.

“Alkylene” is the multivalent (e.g., divalent or trivalent) form of the “alkyl” groups defined above.

“Arylalkylene” refers to an “alkylene” moiety to which an aryl group is attached.

“Aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups, examples of which include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

The term “polymer” refers to a molecule having a structure which includes the multiple repetition of units derived, actually or conceptually, from one or more monomers. The term “monomer” refers to a molecule of low relative molecular mass that can combine with others to form a polymer. The term “polymer” includes homopolymers and copolymers, as well as homopolymers or copolymers that may be formed in a miscible blend, e.g., by coextrusion or by reaction. The term “polymer” includes random, block, graft, and star polymers. The term “polymer” encompasses oligomers.

A “monomer unit” of a polymer or oligomer is a segment of a polymer or oligomer derived from a single monomer.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent. The term “crosslinked” includes partially crosslinked.

The “elastic modulus” as used herein is synonymous with Young's modulus, the modulus of elasticity, and the DMT modulus.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

The disclosure may be more completely understood in consideration of the following detailed description of various embodiments of the disclosure in connection with the accompanying drawings, in which:

FIG. 1 is a side view of an embodiment of an adhesive film of the present disclosure; and

FIG. 2 is a side view of an embodiment of an adhesive film of the present disclosure including the single adhesive layer between two substrates.

### DETAILED DESCRIPTION

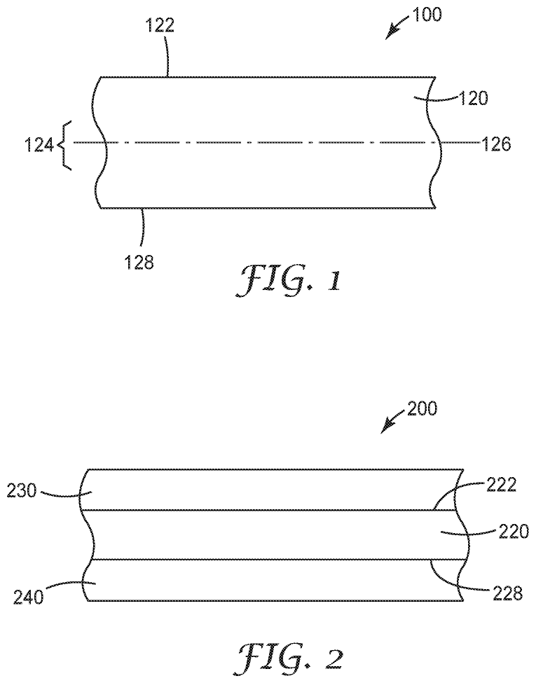

FIG. 1 illustrates an embodiment of an adhesive film 100 of the present disclosure. The adhesive film 100 includes a single adhesive layer 120 having a first major surface 122, a second major surface 128, and a core 124 between the first and second opposing major surfaces 122, 128. The core 124 includes the plane 126 centered between the first and second opposing major surfaces 122, 128. For the purposes of this disclosure, the core includes at least 50 percent of the total thickness of the single adhesive layer disposed around the plane centered between the first and second opposing major surfaces. In some embodiments, the core includes at least 60, 70, 80, or 90 percent of the total thickness of the single adhesive layer. In some embodiments, the core includes up to 99 percent of the total thickness of the film or more.

The adhesive film includes a single adhesive layer comprising an acrylic polymer. A single adhesive layer is typically made by a single deposition of a single formulation. The acrylic polymer in the single adhesive layer generally has the same monomeric units at the first and second opposing major surfaces and at the core while the molecular weight or level of crosslinking is generally different at the first and second opposing major surfaces and at the core. Any component of the single adhesive layer (e.g., the acrylic polymer and the ultraviolet light absorber), can be found throughout the thickness of the single adhesive layer including at the first and second major surfaces and at the core. As explained in further detail below, the single adhesive layer typically has a gradient cure profile between the outer surfaces and the core. The single adhesive layer is generally free of sharp transitions in formulation and has no lamination interface. Thus, the single adhesive layer is not a multi-layer construction having two or more layers of different adhesive compositions.

To determine whether an adhesive film is a single layer, a cross section can be cut from the film and examined by optical microscopy (e.g., transmission electron microscopy (TEM)), for example. For a single adhesive layer, no interface or substantially no interface would be observable in the cross section. Samples can be prepared, for example, by embedding them in epoxy resin. After the epoxy is cured, thin sections (e.g., approximately 120 nm to 160 nm thick) can be cut at −70° C., for example. With or without staining (e.g., with RuO₄), TEM samples can be imaged inside an FEI Tecnai Osiris TEM (FEI Company, Hillsboro, OR) under a 200 keV electron beam with low a dose. Cryo-transfer TEM, which can maintain low temperature from sample preparation, transfer into the TEM, and finally imaging inside the TEM, may be useful.

The single adhesive layer in the adhesive film of the present disclosure is typically a pressure-sensitive adhesive (PSA) layer. PSAs are well known to those of ordinary skill in the art to possess properties including the following: (1) aggressive and permanent tack, (2) adherence with no more than finger pressure, (3) sufficient ability to hold onto an adherend, and typically, (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. One method useful for identifying pressure sensitive adhesives is the Dahlquist criterion. This criterion defines a pressure sensitive adhesive as an adhesive having a creep compliance of greater than 3×10⁻⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 3×10⁵ N/m².

As used herein, the term “acrylic” or “acrylate” includes compounds having at least one of acrylic or methacrylic groups. Useful acrylic PSAs can be made, for example, by combining at least two different monomers (i.e., first and second monomers). The monomers, including any of those described below, become monomer units in the acrylic polymer as would be understood by a person skilled in the art. First monomers and second monomers are typically monofunctional monomers, that is, having only one group per molecule that undergoes free radical polymerization. Examples of suitable first monomers include those represented by Formula I:

$${CH}_{2} = C ( {R}^{′} ) COOR \qquad ( I )$$

wherein R′ is hydrogen or a methyl group and R is an alkyl group having 4 to 18, 4 to 16, 4 to 12, 6 to 12, or 8 to 12 carbon atoms, which may be linear, branched, cyclic, or polycyclic. Examples of suitable first monomers represented by Formula I include n-butyl acrylate, s-butyl acrylate, t-butyl acrylate, n-pentyl acrylate, isopentyl acrylate, hexyl acrylate, cyclohexyl acrylate, heptyl acrylate, isoamyl acrylate, 2-ethylhexyl acrylate, n-octyl acrylate, 2-octyl acrylate, isooctyl acrylate, n-nonyl acrylate, isononyl acrylate, n-decyl acrylate, isodecyl acrylate, n-dodecyl acrylate, isomyristyl acrylate, n-tridecyl acrylate, n-tetradecyl acrylate, stearyl acrylate, isostearyl acrylate, isobornyl acrylate, 2-methylbutyl acrylate, 4-methyl-2-pentyl acrylate, methacrylates of the foregoing acrylates, and combinations thereof. Suitable first monomers further include mixtures of at least two or at least three structural isomers of a secondary alkyl (meth)acrylate of Formula (II):

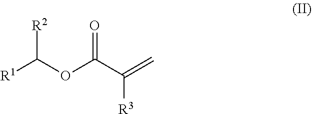

wherein R¹ and R² are each independently a C₁ to C₃₀ saturated linear alkyl group; the sum of the number of carbons in R¹ and R² is 7 to 31; and R³ is H or CH₃. The sum of the number of carbons in R¹ and R² can be, in some embodiments, 7 to 27, 7 to 25, 7 to 21, 7 to 17, 7 to 11, or 7. Methods for making and using such monomers and monomer mixtures are described in U.S. Pat. No. 9,102,774 (Clapper et al.).

Second monomer units can be more polar than the first monomer units. Examples of suitable second monomers useful for preparing acrylic PSAs include an acrylic acid (e.g., acrylic acid, methacrylic acid, itaconic acid, maleic acid, and fumaric acid), an acrylamide (e.g., acrylamide, methacrylamide, N-ethyl acrylamide, N-hydroxyethyl acrylamide, N-octyl acrylamide, N-t-butyl acrylamide, N,N-dimethyl acrylamide, N,N-diethyl acrylamide, N-ethyl-N-dihydroxyethyl acrylamide, and methacrylamides of the foregoing acrylamides), a hydroxyl- or amino-substituted acrylate (e.g., 2-hydroxyethyl acrylate, 3-hydroxypropyl acrylate, 2-hydroxybutyl acrylate, 4-hydroxybutyl acrylate, 6-hydroxyhexyl acrylate, 8-hydroxyoctyl acrylate, 10-hydroxydecyl acrylate, 12-hydroxylauryl acrylate, (4-hydroxymethylcyclohexyl)methyl acrylate, dimethylaminoethyl acrylate, t-butylaminoethyl acrylate, aminoethyl acrylate, N,N-dimethyl aminoethyl acrylate, N,N-dimethylaminopropyl acrylate, and methacrylates of the foregoing acrylates), N-vinyl pyrrolidone, N-vinyl caprolactam, an alpha-olefin, a vinyl ether, a vinyl ester (e.g., vinyl acetate, vinyl benzoate, vinyl 4-tert-butylbenzoate, vinyl cinnamate, vinyl decanoate, vinyl neodecanoate, vinyl neononanoate, vinyl pivalate, vinyl propionate, vinyl stearate, and vinyl valerate), an allyl ether, a styrenic monomer (e.g., 4-tert-butoxystyrene, 4-(tert-butyl)styrene, 4-chloromethylstyrene, chloromethylstyrene, 3-chlorostyrene, 2 (diethylamino)ethylstyrene, 2-methylstyrene, 4-methylstyrene, 4-nitrostyrene, and 4 vinylbenzoic acid), a maleate, and combinations thereof. In some embodiments, the acrylic polymer comprises monomer units of at least one of acrylic acid, methacrylic acid, acrylamide, acrylonitrile, methacrylonitrile, an N-substituted acrylamide, an N,N-disubstituted acrylamide, a hydroxyalkyl acrylate, N-vinyl caprolactam, N-vinyl pyrrolidone, maleic anhydride, or itaconic acid.

Crosslinked acrylic PSAs may be made, for example, by including one or more polyfunctional crosslinking monomers in the formulation. Suitable polyfunctional monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, dimethacrylates of any of the foregoing diacrylates, and combinations thereof. Further suitable polyfunctional monomers include polyacrylate esters of polyols, such as glycerol triacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof.

Typically, the first monomer is used in an amount of 75 weight percent to 100 weight percent based on a total weight of monomers to make the acrylic polymer, and a second monomer as described above is used in an amount of 0 weight percent to 25 weight percent based on a total weight of monomers to make the acrylic polymer. In some embodiments, the first monomer is used in an amount of at least 80, 85, 90, 92, 95, 97, 98, or 99 percent by weight based on the total weight of the monomers, and the second monomer is used in an amount of up to 20, 15, 10, 8, 5, 3, 2, or 1 percent by weight based on the total weight of the monomers. These percentages also reflect the percentages of the various monomer units in the acrylic polymer. When present, the polyfunctional crosslinking monomer can be used in an amount of 0.002 to 2 parts per hundred parts of the monofunctional monomers, for example, from about 0.01 to about 0.5 parts or from about 0.05 to 0.15 parts per hundred parts of the monofunctional monomers.

Some suitable combinations of monomers are disclosed in U.S. Pat. No. 5,024,880 (Vesley et al.), U.S. Pat. No. 9,879,161 (Xia et al.), and U.S. Pat. No. 10,214,666 (Nakada et al.) and U.S. Pat. Appl. Pub. Nos. 2011/0031435 (Yoda et al.) and 2019/0316004 (Clapper et al.). In some embodiments, the acrylic polymer comprises first monomer units of at least one of 2-ethylhexyl acrylate, 2-ethylhexyl methacrylate, or isooctyl acrylate. In some embodiments, the acrylic polymer comprises monomer units of at least one of 2-ethylhexyl acrylate, 2-ethylhexyl methacrylate, or isooctyl acrylate in an amount of at least 50 percent by weight, based on the total weight of the polymer. In some embodiments, the acrylic polymer comprises monomer units of at least one of 2-ethylhexyl acrylate, 2-ethylhexyl methacrylate, 2-hydroxyethyl acrylate, or isobornyl acrylate. In some embodiments, a ratio of these monomers described in the Examples below, for example, can be useful. Regarding these monomers, in some embodiments, at least a portion of the 2-hydroxylethyl acrylate can be substituted with at least one of another polar monomer such as acrylic acid, methacrylic acid, acrylamide, acrylonitrile, methacrylonitrile, an N-substituted acrylamide, or an N,N-disubstituted acrylamide such that the acrylic polymer includes at least 1.5, 2, 5, 10, or 12 percent by weight of any of these monomers, based on the weight of the monofunctional monomer units in the polymer. In some embodiments, the acrylic polymer comprises at least one of acrylic acid or N,N-dimethylacrylamide in any of these amounts.

An acrylic polymer can be analyzed by nuclear magnetic resonance spectroscopy (¹H or ¹³C NMR) to identify the monomer units in the polymer. Solid state or solution NMR may be useful depending on the level of crosslinking in the polymer. For solid state NMR the acrylic polymer can be swelled in an appropriate solvent for analysis.

The single adhesive layer in the adhesive film of the present disclosure includes an ultraviolet light absorber capable of absorbing in a wavelength range between 320 nanometers (nm) and 390 nm, between 350 nm and 390 nm, or between 350 nm and 380 nm. The ultraviolet light absorber is typically a compound capable of absorbing or blocking electromagnetic radiation at wavelengths less than 400 nm while remaining substantially transparent at wavelengths greater than 400 nm. Ultraviolet light absorbers are known to those skilled in the art as being capable of dissipating absorbed light energy from UV rays as heat by reversible intramolecular proton transfer. Such compounds can intervene in the physical and chemical processes of photoinduced degradation. The ultraviolet light absorber does not generate radicals upon exposure to light, does not undergo a cleavage reaction, and does not initiate polymerization or crosslinking. Therefore, the ultraviolet light absorber in the single adhesive layer is not a photoinitiator.

Any class of ultraviolet light absorber may be useful. Examples of useful classes include benzophenones, benzotriazoles, triazines, cinnamates, cyanoacrylates, dicyano ethylenes, salicylates, oxanilides, and para-aminobenzoates. In some of these embodiments, the ultraviolet light absorber comprises at least one of an ortho-hydroxy benzophenone, an ortho-hydroxy benzotriazole, or an ortho-hydroxy triazine. Suitable ultraviolet light absorbers include triazines (e.g., hydrophenyl-substituted triazines such as 2-(4,6-diphenyl-1-3,5-triazin-2-yl)-5-[(hexyl)oxy]phenol and 2-hydroxyphenyl-s-triazine), hydroxybenzophenones, and benzotriazoles (e.g., 5-trifluoromethyl-2-(2-hydroxy-3-alpha-cumyl-5-tert-octylphenyl)-2H-benzotriazole, 2-(2-hydroxy-3,5-di-alpha-cumylphenyl)-2H-benzotriazole, 5-chloro-2-(2-hydroxy-3-tert-butyl-5-methylphenyl)-2H-benzotiazole, 5-chloro-2-(2-hydroxy-3,5-di-tert-butylphenyl)-2H-benzotriazole, 2-(2-hydroxy-3,5-di-tert-amylphenyl)-2H-benzotriazole, 2-(2-hydroxy-3-alpha-cumyl-5-tert-octylphenyl)-2H-benzotriazole, and 2-(3-tert-butyl-2-hydroxy-5-methylphenyl)-5-chloro-2H-benzotriazole). Suitable ultraviolet light absorbers include those available, for example, from BASF, Florham Park, N.J., under the trade designation “TINUVIN”.

The ultraviolet light absorber can also be copolymerized with the monomers useful to make the acrylic polymer. Examples of suitable polymerizable ultraviolet light absorbers include 2-(cyano-β,β-biphenylacryloyloxy)ethyl-1-methacrylate, 2-(α-cyano-β,β-biphenylacryloyloxy)ethyl-2-methacrylamide, N-(4-methacryloylphenol)-N′-(2-ethylphenyl)oxamide, vinyl 4-ethyl-α-cyano-β-phenylcinnamate, 2-hydroxy-4-(2-hydroxy-3-methacryloyloxypropoxy)benzophenone, 2-hydroxy-4-methacryloyloxybenzophenone, 2-hydroxy-4-(2-acryloyloxyethoxy)benzophenone, 2-hydroxy-4-(4-acryloyloxybutoxy)benzophenone, 2,2′-dihydroxy-4-(2-acryloyloxyethoxy)benzophenone, 2-hydroxy-4-(2-acryloyloxyethoxy)-4′-(2-hydroxyethoxy)benzophenone, 4-(allyloxy)-2-hydroxybenzophenone, 2-(2′-hydroxy-3′-methacrylamidomethyl-5′-octylphenyl)benzotriazole, 2-(2-hydroxy-5-vinylphenyl)-2-benzotriazole, 2-(2H-benzotriazol-2-yl)-4-methyl-6-(2-propenyl)phenol, 2-(2′-hydroxy-5′-methacryloyloxyethylphenyl)-2H-benzotriazole, 2-(2′-hydroxy-5′-methacryloyloxyethylphenyl)-5-chloro-2H-benzotriazole, 2-(2′-hydroxy-5′-methacryloyloxypropylphenyl)-2H-benzotriazole, 2-(2′-hydroxy-5′-methacryloyloxypropylphenyl)-5-chloro-2H-benzotriazole, 2-(2′-hydroxy-3′-tert-butyl-5′-methacryloyloxyethylphenyl)-2H-benzotriazole, 2-(2′-hydroxy-3′-tert-butyl-5′-methacryloyloxyethylphenyl)-5-chloro-2H-benzotriazole, 2,4-diphenyl-6-[2-hydroxy-4-(2-acryloyloxyethoxy)]-1,3,5-triazine, 2,4-bis(2-methylphenyl)-6-[2-hydroxy-4-(2-acryloyloxyethoxy)]-1,3,5-triazine, 2,4-bis(2-methoxyphenyl)-6-[2-hydroxy-4-(2-acryloyloxyethoxy)]-1,3,5-triazine, 2,4-bis(2-ethylphenyl)-6-[2-hydroxy-4-(2-acryloyloxyethoxy)]-1,3,5-triazine, 2,4-bis(2-ethoxyphenyl)-6-[2-hydroxy-4-(2-acryloyloxyethoxy)]-1,3,5-triazine, 2,4-diphenyl-6-[2-hydroxy-4-(2-methacryloyloxyethoxy)]-1,3,5-triazine, 2,4-bis(2-methylphenyl)-6-[2-hydroxy-4-(2-methacryloyloxyethoxy)]-1,3,5-triazine, 2,4-bis(2-methoxyphenyl)-6-[2-hydroxy-4-(2-methacryloyloxyethoxy)]-1,3,5-triazine, 2,4-bis(2-ethylphenyl)-6-[2-hydroxy-4-(2-methacryloyloxyethoxy)]-1,3,5-triazine, 2,4-bis(2-ethoxyphenyl)-6-[2-hydroxy-4-(2-methacryloyloxyethoxy)]-1,3,5-triazine, 2,4-bis(2,4-dimethoxyphenyl)-6-[2-hydroxy-4-(2-acryloyloxyethoxy)]-1,3,5-triazine, 2,4-bis(2,4-dimethylphenyl)-6-[2-hydroxy-4-(2-acryloyloxyethoxy)]-1,3,5-triazine, 2,4-bis(2,4-diethoxyphenyl)-6-[2-hydroxy-4-(2-acryloyloxyethoxy)]-1,3,5-triazine, 2,4-bis (2,4-diethylphenyl)-6-[2-hydroxy-4-(2-acryloyloxyethoxy)]-1,3,5-triazine, methacrylates of the foregoing acrylates and acrylates of the foregoing methacrylates.

In the single adhesive layer, the first and second opposing major surfaces each has an elastic modulus that is higher than an elastic modulus of the core, or the first and second opposing major surfaces each has an elastic modulus that is lower than an elastic modulus of the core. In some embodiments, the elastic modulus of each of the first and second opposing major surfaces is higher than the elastic modulus of the core. In some embodiments, the elastic modulus of each of the first and second opposing major surfaces is lower than the elastic modulus of the core.

The elastic modulus of each of the first and second opposing major surfaces can be determined by atomic force microscopy (AFM)-based nanoindentation. The elastic modulus of the core can also be determined using this technique after embedding a sample of the single adhesive layer in a suitable resin such as an epoxy and obtaining a cross-section of the single adhesive layer by cryo-microtomy. In AFM, a small sharp probe tip attached to the end of a cantilever is raster-scanned across a surface. The AFM cantilever bends as the tip is scanned; the cantilever bending force is described by Hooke's Law: Fc=−kx, where k is the cantilever spring constant, Fc is the force of the cantilever and x is the cantilever deflection. A method useful for determining elastic modulus employs a dynamic AFM mode called peak force tapping, where the tip is modulated at 2 kHz so the tip and the surface are brought intermittently together. At each x-y position, the maximum force (peak force) between tip and sample is kept constant to create a three-dimensional topography map of a surface. In addition to topographic imaging, this mode acquires force-distance curves between tip and sample at each pixel of the image channel. A force-distance curve is obtained as the tip approaches towards the surface and withdraws from the surface. The Peakforce Tapping Mode used in the Examples, below, calculates the modulus using the DMT model. For the purposes of this disclosure, the method described in the Examples below can be used.

Using AFM-based nanoindentation, measuring the first and second opposing major surfaces typically entails measuring the first 20 nm, 10 nm, or 5 nm in depth at each surface. The first and second major surfaces may provide up to 0.2 percent (that is, up to 0.1 percent each) of the total thickness of the single adhesive layer. For example, for a single adhesive layer that is 25 micrometers in thickness, 20 nm is 0.08 percent of the total thickness. However, up to 50 percent of the total thickness of the single adhesive layer can have the same elastic modulus as first and second opposing major surfaces, depending on the conditions used for making the single adhesive layer. While the core includes at least 50, 60, 70, 80, 90, or 99 percent of the total thickness of the single adhesive layer disposed around the plane centered between the first and second opposing major surfaces, up to 50, 40, 30, 20, 10, or 1 percent of the total cross-section of the single adhesive layer (that is, up to 25, 20, 15, 10, or 5 percent of the thickness at each surface) may have an elastic modulus that is either lower or higher than that of the core. For the purposes of this disclosure, the elastic modulus of each of the first and second opposing major surfaces is measured at the surfaces, while the elastic modulus of the core is measured on a cross-section of the adhesive film at approximately the center plane of the cross-section.

For convenience of analysis, the bulk modulus can also be useful for determining the elastic modulus of the first and second opposing major surfaces and the core. As described in the Examples below, a relatively thin sample and a relatively thick sample (e.g., five to ten times the thickness of the thin sample) can be prepared for each composition including at least one acrylic monomer (e.g., first and second acrylic monomers as described above in any of their embodiments) and the ultraviolet light absorber. The thin samples can be, for example, 25 micrometers (um) to 50 um thick, and the thick samples can be, for example, 125 um to 500 um thick. The samples can then be cured, for example, according to any of the methods described below. The thinner samples have a larger proportion of the outer layers, and when tested in a bulk modulus test, the results are dominated by the modulus of the first and second major surfaces. The thicker samples have a larger proportion of the core, and bulk modulus testing of the thicker samples can provide results dominated by the modulus of the core.

Using either of these methods, AFM-based nanoindentation or bulk modulus on relatively thinner and relatively thicker samples, the terms “higher” and “lower” with respect to elastic modulus mean that the first and second opposing major surfaces have an elastic modulus that is at least five percent higher or five percent lower than that of the core. In some embodiments, the first and second opposing major surfaces have an elastic modulus that is at least 10, 15, 20, or 25 percent higher or 10, 15, or 20 percent lower than that of the core. On the other hand, the elastic modulus of the first major surface and the elastic modulus of the second major surface can be the same or similar to each other. In some embodiments, the elastic modulus of the first major surface is in a range from 80 percent to 120 percent, 85 percent to 115 percent, 90 percent to 110 percent, or 95 percent to 105 percent of the elastic modulus of the opposing second major surface.

The single adhesive layer useful for the adhesive film of the present disclosure can be prepared, for example, by a solvent free, free-radical polymerization process. Such polymerizations are typically facilitated by a free-radical initiator (e.g., a photoinitiator). The process can include providing a layer of a composition comprising at least one acrylic monomer, for example, first and second acrylic monomers as described above in any of their embodiments, the ultraviolet light absorber capable of absorbing in the wavelength range between 320 nanometers (nm) and 390 nm, and typically a photoinitiator. Both sides of the layer of the composition are irradiated at the wavelength range between 320 nm and 390 nm, and both sides of the layer of the composition are irradiated at a wavelength at which the ultraviolet light absorber does not absorb. The method of the present disclosure includes irradiation at the wavelength range between 320 nm and 390 nm and irradiation at a wavelength at which the ultraviolet light absorber does not absorb in either order. The ultraviolet light absorber can prevent the light in the wavelength range between 320 nm and 390 nm from reaching the core of the layer of the composition or can greatly reduce the dose of this light to which the core of the layer of the composition is exposed. Irradiation at a wavelength at which the ultraviolet light absorber does not absorb can initiate polymerization throughout the thickness of the sample. The intensity of the light and the order of irradiation can be useful for controlling whether the elastic modulus of each of the first and second opposing major surfaces is higher or lower than the modulus of the core.

Depending on the photoinitator and ultraviolet light absorber used, the layer of the composition can be exposed to radiation having a wavelength in a range of about 320 nm to about 350 nm, about 350 nm to about 390 nm, or about 350 nm to about 380 nm. Also depending on the photoinitiator used, the layer of the composition can be exposed to radiation at any wavelength at which the ultraviolet light absorber does not absorb, for example, any wavelength or wavelengths in a range from 400 nm to 500 nm, from 400 nm to 450 nm, from 390 nm to 425 nm, or from 400 nm to 420 nm. Any suitable light source may be used, including fluorescent UV bulbs, mercury lamp (e.g., a low-pressure mercury lamp, a medium-pressure mercury lamp, a high-pressure mercury lamp, an ultrahigh-pressure mercury lamp), a xenon lamp, a metal halide lamp, an electrodeless lamp, an incandescent lamp, LEDs, and lasers. The amount of UV irradiation is typically from approximately 1,000 mJ/cm² to approximately 5,000 mJ/cm². An amount of UV irradiation in a range from approximately 1,000 mJ/cm² to approximately 3,000 mJ/cm² can also be useful. For broadband light sources (e.g., a fluorescent UV bulb, mercury lamp, or incandescent lamp), filters may be useful for narrowing the wavelength ranges to be within or outside the wavelength at which the ultraviolet light absorber absorbs and/or to modify the intensity of the light source.

In the Examples, below, the process of irradiating both sides of a layer of a composition at the wavelength range between 320 nanometers and 390 nanometers and irradiating both sides of the layer of the composition at a wavelength at which the ultraviolet light absorber does not absorb was carried out on samples having different thicknesses. In Example 1, irradiation with light in the wavelength range between 320 nanometers and 390 nanometers is believed to provide polymerization at the first and second major surfaces. Polymerization at the core does not occur or occurs to a much lesser extent because of the ultraviolet light absorber absorbing in a wavelength range of 320 to 390 nanometers. Irradiation at higher intensity at a wavelength at which the ultraviolet light absorber does not absorb is believed to provide shorter polymer chain lengths in the core of the samples, which results in a lower tan delta in the thinner sample vs. the thicker samples, providing evidence that the first and second major surfaces have a higher modulus than the core. Tan delta is calculated from the loss modulus (G″) divided by the storage modulus (G′) (tan delta=G″/G′). A higher tan delta indicates the adhesive film is more fluid, and a lower tan delta indicates the adhesive film is more elastic. As shown in Illustrative Examples A to C, this effect is not observed when no ultraviolet light absorber is present in the composition and when only light at a wavelength at which the ultraviolet light absorber does not absorb is used to polymerize the samples. In Examples 8 and 9, irradiation with light in the wavelength range between 320 nanometers and 390 nanometers at a higher intensity than in Example 1 is believed to provide shorter polymer chain lengths than in Example 1, which results in a higher increase in tan delta in the thinner sample vs. the thicker samples, providing evidence that the first and second major surfaces have a lower modulus than the core. Thus, the Examples demonstrate an adhesive film having multi-layer-like properties provided with a single adhesive layer.

The ultraviolet light absorber can be present in any useful amount. In some embodiments, the ultraviolet light absorber is present in an amount of up to 5, 4, 3, 2, 1.5, 1, or 0.8 parts per hundred parts of monofunctional monomers in the composition. In some embodiments, the ultraviolet light absorber is present in an amount of at least 0.005, 0.1, or 0.2 parts per hundred parts of monofunctional monomers in the composition. In some embodiments, the ultraviolet light absorber is present in a range from 0.1 part to three parts by weight, 0.1 part to two parts by weight, or 0.1 to one part by weight, based on one hundred parts of monofunctional monomers in the composition. In some embodiments, the ultraviolet light absorber is present in an amount of up to 5, 4, 3, 2, 1.5, 1, or 0.8 percent by weight, based on the total weight of the adhesive layer. In some embodiments, the ultraviolet light absorber is present in an amount of at least 0.005, 0.1, or 0.2 percent by weight, based on the total weight of the adhesive layer. In some embodiments, the ultraviolet light absorber is present in a range from 0.1 to 3 percent by weight, 0.1 to 2 percent by weight, or 0.1 to 1 percent by weight, based on the total weight of the adhesive layer. As shown in the Examples, below, any of these ranges is useful for providing a single adhesive layer with first and second major surfaces having a different elastic modulus than the elastic modulus of the core.

Certain photoinitiators, when used, can be consumed upon reaction with light and may not be present in the adhesive film of the present disclosure. In some embodiments, the single adhesive layer further comprises a photoinitiator or a fragment thereof. Any suitable photoinitiator may be useful in the composition comprising at least one acrylic monomer, for example, first and second acrylic monomers as described above in any of their embodiments, and the ultraviolet light absorber capable of absorbing in the wavelength range between 320 nanometers and 390 nanometers. Suitable photoinitiators include type I or type II photoinitiators. Suitable photoinitiators may include acetophenones, benzilketal, alkylaminoacetophenones, benzoyl phosphine oxides, benzoin ethers, benzophenones, and benzoylformate esters. In some embodiments, the free radical photoinitiator is a type I (cleavage-type) photoinitiator. Cleavage-type photoinitiators include acetophenones, alpha-aminoalkylphenones, benzoin ethers, benzoyl oximes, acyl (e.g., benzoyl) phosphine oxides, acyl (e.g., benzoyl) phosphinates, and mixtures thereof.

Examples of useful benzoin ethers include benzoin methyl ether and benzoin butyl ether. Examples of suitable acetophenone compounds include 4-diethylaminoacetophenone, 1-hydroxycyclohexyl phenyl ketone, 2-benzyl-2 dimethylamino-4′-morpholinobutyrophenone, 2-hydroxy-2-methyl-1-phenylpropan-1 one, and 2,2-dimethoxy-1,2-diphenylethan-1-one. Example of suitable acyl phosphine oxide, acyl phosphinate, and acyl phosphonate compounds include those represented by formula

(R⁴)₂—P(═O)—C(═O)—R⁵

wherein each R⁴ is independently alkyl, alkoxy, cycloalkyl, aryl, arylalkylenyl, an S-, O-, or N-containing five- or six-membered heterocyclic ring any of which can be substituted with a halo-, alkyl- or alkoxy-group, or the two R⁴ groups can be joined to form a ring along with the phosphorous atom, or one R⁴ group may be —C(═O)—R⁵, and wherein R⁵ is alkyl, cycloalkyl, aryl, arylalkylenyl, an S-, O-, or N-containing five- or six-membered heterocyclic ring, or a —Z—C(═O)—P(═O)—(R⁴)₂ group, wherein Z is alkylene having from 2 to 6 carbon atoms or arylene. In some embodiments, each R⁴ is independently alkyl having up to eight carbon atoms, alkoxy having up to four carbon atoms, phenyl, or —C(═O)—R⁵, and each R⁵ is independently aryl or alkyl having up to eight carbon atoms. Suitable aryl groups include phenyl and phenyl substituted by two or three alkyl groups, alkoxy groups, or halogens (e.g., chloro). Specific examples of acyl phosphine oxides, acyl phosphinates, and acyl phosphonates include bis(2,6-dimethoxybenzoyl)-2,4,4-trimethylpentyl phosphine oxide, phenylbis(2,4,6-trimethylbenzoyl) phosphine oxide, ethyl phenyl(2,4,6-trimethylbenzoyl)phosphinate, (2,4,6-trimethylbenzoyl)diphenylphosphine oxide, dimethyl pivaloylphosphonate, and poly(oxy-1,2-ethanediyl), α,α′,α″-1,2,3-propanetriyltris[ω-[[phenyl(2,4,6-trimethylbenzoyl)phosphinyl]oxy]. Many photoinitiators are available, for example, from BASF, Vandalia, Ill. under the trade designation “IRGACURE”, from IGM Resins, Waalwijk, Netherlands, under the trade designations “OMNIRAD” and “ESACURE”. Two or more of any of these photoinitiators may also be used together in any combination.

Type 1 photoinitiators undergo photocleavage to produce radicals that can initiate free radical polymerization. These radicals can be incorporated as end groups on the polymer chains. Such end groups can be detected by certain analytical (e.g., spectroscopic) techniques. In some cases, the fragments generated from photocleavage can undergo various rearrangements that result in the formation of small molecules (e.g., formaldehyde, acetone, acetaldehyde, toluene, methyl benzoate, and benzaldehyde). Such small molecules also constitute fragments of a photoinitiator and can be detected, for example, by Thermal Desorption Mass Spectrometry (TD-MS). Extraction of a crosslinked single adhesive layer by an appropriate solvent can be useful for obtaining the small molecules from the single adhesive layer for analysis. TD-MS can be performed with an Agilent 7890B GC (Agilent, Santa Clara, CA)+5977B MSD+Gerstel MPS with TD3.5+ instrument equipped with a Restek Rtx-5MS w/Integra-Guard, 30 m×0.25 mm 0.25 um film column, with EI mass spectrometry 70 eV (Scan 29-550 Da) detection. In some embodiments, the single adhesive layer comprises the fragment of the photoinitiator. In some of these embodiments, the fragment comprises at least one of benzaldehyde, 2,4,6-trimethylbenzaldehyde, benzoic acid, 2,4,6-trimethylbenzoic acid, benzil, methyl benzoate, acetophenone, isopropanol, acetone, glycol, formaldehyde, toluene, acetaldehyde, diphenylphosphine oxide, or ethyl phenylphosphinate.

The photoinitiator may be selected, for example, based on the desired wavelength for curing and compatibility with the composition. The photoinitiator typically absorbs at a wavelength at which the ultraviolet light absorber does not absorb. The photoinitiator may have an extinction coefficient of more than 5 L/(mol*cm), more than 2 L/(mol*cm), more than 1 L/(mol*cm), more than 0.1 L/(mol*cm), or more than 0 L/(mol*cm) at a wavelength at which the ultraviolet light absorber does not absorb. In some embodiments, the photoinitator has an absorbance in a range from 400 nm to 500 nm, from 400 nm to 450 nm, or from 400 nm to 420 nm. When it is said that the photoinitiator has an absorbance at any of these wavelengths or in any of these ranges, it may have any absorbance that is able to effectively start the polymerization, in some embodiments, having any of the extinction coefficients described above. The photoinitiator typically also absorbs at a wavelength at which the ultraviolet light absorber absorbs with any of the extinction coefficients described above.

The photoinitiator can be used in any amount effective to facilitate polymerization of the monomers (e.g., 0.1 part to about 5 parts, 0.2 part to about 2 parts, or about 0.1 part to about 1 part per hundred parts of the monofunctional monomers used to make the acrylic polymer.

In some embodiments, the acrylic polymer in the single adhesive layer includes a photoinitiator which can be considered a photocrosslinker. Examples of suitable photocrosslinkers include ethylenically unsaturated compounds which in the excited state are capable of abstracting hydrogen (e.g., acrylated benzophenones such as described in U.S. Pat. No. 4,737,559 (Kellen et al.)), p-acryloxybenzophenone, which is available from Sartomer Company, Exton, PA, monomers described in U.S. Pat. No. 5,073,611 (Rehmer et al.) including p-N-(methacryloyl-4-oxapentamethylene)-carbamoyloxybenzophenone, N-(benzoyl-p-phenylene)-N′-(methacryloxymethylene)-carbodiimide, and p-acryloxy-benzophenone), and para-acryloxyethoxybenzophenone; monofunctional benzophenones (e.g., benzophenone, 4-phenylbenzophenone, 4-methoxybenzophenone, 4,4-dimethoxybenzophenone, 4,4′-dimethylbenzophenone, 4-methylbenzophenone, 4-(2-hydroxyethylthio)-benzophenone, and 4-(4-tolylthio)-benzophenone); polyfunctional benzophenones (e.g., di-esters of carboxymethoxy-benzophenone and polytetramethyleneglycol 250); anthraquinone photocrosslinkers (e.g., anthraquinone, 2-methyl anthraquinone, 2-t-butyl anthraquinone, 2-ethyl anthraquinone, 2-phenyl anthraquinone, 1,4-dimethyl anthraquinone, 2,3-dimethyl anthraquinone, 1,2-dimethyl anthraquinone, 1-methoxy-2-methyl anthraquinone, 2-acetyl anthraquinone, and 2,6-di-t-butyl anthraquinone); thioxanthone photocrosslinkers (e.g., thioxanthone, 2-isopropylthioxanthone, 2-chlorothioxanthone, 2-dodecylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 1-ethoxycarbonyl-3-(1-methyl-1-morpholinoethyl)-thioxanthone, 2-methyl-6-dimethoxymethylthioxanthone, 2-methyl-6-(1,1-dimethoxybenzyl)-thioxanthone, 2-morpholinomethylthioxanthone, 2-methyl-6-morpholinonethylthioxanthone, N-allylthioxanthone-3,4-dicarboximide, N-octylthioxanthone-3,4-dicarboximide, N-(1,1,3,3-tetramethylbutyl)-thioxanthone-3,4-dicarboximide, 6-ethoxycarbonyl-2-methoxythioxanthone; and 6-ethoxycarbonyl-2-methylthioxanthone); halomethyl-1, 3, 5-triazines (e.g., 2,4-bis(trichloromethyl)-6-(4-methoxy)phenyl)-s-triazine; 2,4-bis(trichloromethyl)-6-(3,4-dimethoxy)phenyl)-s-triazine; 2,4-bis(trichloromethyl)-6-(3,4,5-trimethoxy)phenyl)-s-triazine; 2,4-bis(trichloromethyl)-6-(2,4-dimethoxy)phenyl)-s-triazine; 2,4-bis(trichloromethyl)-6-(3-methoxy)phenyl)-s-triazine as described in U.S. Pat. No. 4,330,590 (Vesley); and 2,4-bis(trichloromethyl)-6-naphthenyl-s-triazine and 2,4-bis(trichloromethyl)-6-(4-methoxy)naphthenyl-s-triazine as described in U.S. Pat. No. 4,329,384 (Vesley)). The photocrosslinkers may be present in the acrylic polymer in any useful amount. For example, an amount of 0.001 to 10 parts, 0.001 to 5 parts, 0.001 to 2 parts, 0.001 to 1 parts, 0.001 to 0.5 parts, or 0.001 to 0.1 parts per hundred parts of the monofunctional monomers may be useful in a composition comprising at least one acrylic monomer, for example, first and second acrylic monomers as described above in any of their embodiments, and the ultraviolet light absorber capable of absorbing in the wavelength range between 320 nanometers and 390 nanometers.

In some embodiments of the single adhesive layer, the acrylic polymer further comprises a pendent benzophenone group. The benzophenone group may be joined to the acrylic polymer backbone through a (meth)acryloyl, a (meth)acryloyloxy, or (meth)acryloyoxyethoxy group at the ortho- or para-position of the first aromatic ring. The first and second aromatic rings may be further substituted with one or more alkyl, alkoxy, or halogen substituents. In some embodiments, the pendent benzophenone group is derived from 4-acryloyloxy benzophenone, 4-acryloyloxy ethoxybenzophenone, 4-acryloyloxy-4′-methoxybenzophenone, 4-acryloyloxyethoxy-4′-methoxybenzophenone, 4-acryloyloxy-4′-bromobenzophenone, 4-acryloyloxyethoxy-4′-bromobenzophenone, 4-methacryloyloxy benzophenone, 4-methacryloyloxyethoxy benzophenone, 4-methacryloyloxy-4′-methoxybenzophenone, 4-methacryloyloxyethoxy-4′-methoxybenzophenone, 4-methacryloyloxy-4′-bromobenzophenone, 4-methacryloyloxyethoxy-4′-bromobenzophenone, or any combination thereof reacted with the first and second monomers described above in any of their embodiments.

As shown in Examples 5 and 10, below, irradiation was carried out at a wavelength at which the ultraviolet light absorber does not absorb and also with relatively high intensity light in the wavelength range between 320 nanometers and 390 nanometers either simultaneously or sequentially, respectively. It is believed that irradiation at a wavelength in a range between 320 nanometers and 390 nanometers crosslinks the outer surfaces by means of the acryloylbenzophenone. This results in a lower tan delta in the thinner sample vs. the thicker samples of Example 5, suggesting that the first and second major surfaces have a higher modulus than the core. As shown in Example 7, the difference in tan delta between the thinner and thicker samples is lower when the composition does not include acryloylbenzophenone. In Example 10, irradiation at a wavelength in a range between 320 nanometers and 390 nanometers results in a higher elastic modulus at the first and second major surfaces than at the core as measured by AFM-nanoindentation. In Illustrative Example F, with irradiation carried out at a wavelength at which the ultraviolet light absorber does not absorb and acryloxylbenzophenone does not absorb, the elastic modulus was the same throughout the thickness of the single adhesive layer.

In some embodiments of the adhesive film of the present disclosure, the acrylic polymer is derived from a composition comprising at least one acrylic monomer, for example, first and second acrylic monomers as described above in any of their embodiments, and a polymer prepared from the partial polymerization of the at least one acrylic monomer. The composition can be a solution of polymer in the at least one monomer and can be, for example, about 3 percent to 15 percent polymerized. In some embodiments, the composition comprises at least 75, 80, 85, 90, or 95 percent by weight monomer(s), based on the total weight of the composition. In some embodiments, the composition is exposed to ultraviolet radiation to provide the solution of the polymer in the at least one acrylic monomer. It is also possible for the solution of the polymer in the at least one acrylic monomer to be made by partial free-radical polymerization using a thermal initiator or other free-radical source.

A useful solvent-free polymerization method is disclosed in U.S. Pat. No. 4,379,201 (Heilmann et al.). Initially, a mixture of first and second monomers can be polymerized with a portion of a photoinitiator by exposing the mixture to UV radiation in an inert environment for a time sufficient to form a coatable base syrup, and subsequently adding a crosslinking agent and the remainder of the photoinitiator. The crosslinking can be, for example, any of the polyfunctional crosslinking monomers described above in any of the amounts described above. This final syrup containing a crosslinking agent (e.g., which may have a Brookfield viscosity of about 500 centipoise (cps) to about 10,000 cps at 23° C., about 100 cps to about 6000 cps at 23° C., or about 5,000 cps to about 7,500 cps at 23° C. as measured with a No. 4 LTV spindle, at 60 revolutions per minute) can then be coated onto a substrate. Once the syrup is coated onto the substrate, further polymerization and crosslinking can be carried out in an inert environment (e.g., nitrogen, carbon dioxide, helium, and argon, which exclude oxygen). A sufficiently inert atmosphere can be achieved by covering a layer of the photoactive syrup with a polymeric film, such as silicone-treated PET film, that is transparent to UV radiation or e-beam irradiation.

The composition including a monomer comprising at least one acrylic monomer and a polymer prepared from the partial polymerization of the at least one acrylic monomer can be applied to the substrate using a variety of methods (e.g., dipping, spraying, brushing, roll coating, bar coating). In some embodiments, the composition can be coated on a liner with a notch bar with a gap setting to provide the desired thickness above the liner, and another liner may be added to maintain a gap of the desired thickness. These coating techniques can also be useful for mixture of monomers not including a polymer prepared from the partial polymerization of monomers.

In some embodiments, the single adhesive layer comprises a tackifier, useful for increasing the stickiness of the surface of a PSA. In some embodiments, single adhesive layer does not comprise a tackifier. Useful tackifiers can have a number average molecular weight of up to 10,000 grams per mole, a softening point of at least 70° C. as determined using a ring and ball apparatus, and a glass transition temperature of at least −30° C. as measured by differential scanning calorimetry. Useful tackifiers are typically amorphous. In some embodiments, the tackifier is miscible with the acrylic polymer of the PSA such that macroscopic phase separation does not occur in the PSA. In some embodiments, the PSA is free of microscopic phase separation as well. In some embodiments, the tackifier comprises at least one of rosin, a rosin ester, an ester of hydrogenated rosin, a polyterpene (e.g., those based on α-pinene, β-pinene, or limonene), an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g. those based on styrene, α-methyl styrene, methyl indene, indene, coumarone, or combinations thereof), or a mixed aliphatic-aromatic hydrocarbon resin. Any of these tackifying resins may be hydrogenated (e.g., partially or completely). Examples suitable tackifiers include those obtained under the trade designations “FORAL 85E” (a glycerol ester of highly hydrogenated refined gum rosin) commercially available from Eastman, Middelburg, NL, “FORAL 3085” (a glycerol ester of highly hydrogenated refined wood rosin) commercially available from Pinova, Brunswick, GA; “ESCOREZ 2520” and “ESCOREZ 5615” (aliphatic/aromatic hydrocarbon resins) commercially available from ExxonMobil Corp., Houston, TX; and “REGALITE 7100” (a partially hydrogenated hydrocarbon resin) commercially available from Eastman, Kingsport, Tennessee.

In some embodiments, the single adhesive layer includes at least about one percent by weight and up to about 50 percent by weight of the tackifier, based on the total weight of the single adhesive layer. In some embodiments, the tackifier is present in a range from 1 to 25, 2 to 20, 2 to 15, 1 to 10, or 3 to 10 percent by weight, based on the total weight of the single adhesive layer.

Plasticizers may be added, e.g., to reduce vitrification of the single adhesive layer. Suitable plasticizers include various polyalkylene oxides (e.g., polyethylene oxides or propylene oxides), adipic acid esters, formic acid esters, phosphoric acid esters, benzoic acid esters, phthalic acid esters, polyisobutylenes, polyolefins, and sulfonamides, naphthenic oils, plasticizing aids such as those materials described as plasticizers in the Dictionary of Rubber, K. F. Heinisch, pp. 359, John Wiley & Sons, New York (1974), oils, elastomer oligomers, and waxes. The amount of plasticizer employed, if one is employed, will depend on the nature of the plasticizer and its compatibility with the single adhesive layer.

In some embodiments, the single adhesive layer is substantially solvent free. Common organic solvents include aliphatic and alicyclic hydrocarbons (e.g., hexane, heptane, and cyclohexane), hydrocarbon solvents (e.g., benzene, toluene, xylenes, and d-limonene); acyclic and cyclic ketones (e.g., acetone, methyl ethyl ketone, and methyl isobutyl ketone, pentanone, hexanone, cyclopentanone, and cyclohexanone); ethers (e.g., diethyl ether, glyme, diglyme, diisopropyl ether, and tetrahydrofuran), esters (e.g., ethyl acetate and butyl acetate), sulfoxides (e.g., dimethyl sulfoxide), amides (e.g., N,N-dimethylformamide, N,N-dimethylacetamide, and N-methyl-2-pyrrolidone), halogenated solvents (e.g., methylchloroform, 1,1,2-trichloro-1,2,2-trifluoroethane, trichloroethylene, and trifluorotoluene), and alcoholic solvents (e.g., methanol, ethanol, or propanol such as isopropanol). The single adhesive layer can be substantially free of any of these solvents. The term “substantially free” means that the single adhesive layer can include up to 0.5, 0.1, 0.05, or 0.01 percent by weight of any of these solvents or can be free of any of these solvents. These percentages are based on the total weight of the single adhesive layer.

A number of additives may also be useful in the adhesive film of the present disclosure. Examples of such adjuvants include antioxidants, such as hindered phenols, amines, and sulfur and phosphorous hydroperoxide decomposers; inorganic fillers such as talc, zinc oxide, titanium dioxide, aluminum oxide, and silica; pigments; dyes; stabilizers (e.g., hindered amine light stabilizers and heat stabilizers); fire retardants; adhesion promoters (e.g., silane coupling agents); and viscosity adjusting agents.

Examples of useful silane coupling agents include alkylsilanes such as hexyltrimethoxysilane, hexyltriethoxysilane and decyltrimethoxysilane; aromatic ring-containing silanes such as phenyltriethoxysilane and p-styryltrimethoxysilane; vinylsilanes such as vinyl trimethoxysilane and vinyl triethoxysilane; epoxysilanes such as 2-(3,4-epoxycyclohexyl)ethyl trimethoxysilane, 3-glycidoxypropyl methyldimethoxysilane, 3-glycidoxypropyltrimethoxysilane, 3-glycidoxypropylmethoxydimethoxysilane and 3-glycidoxypropyltriethoxysilane; (meth)acrylic silanes such as 3-methacryloxypropylmethyldimethoxysilane, 3-methacryloxypropyltrimethoxysilane, 3-methacryloxypropylmethyldiethoxysilane, 3-methacryloxypropyltriethoxysilane and 3-acryloxypropyltrimethoxysilane; and aminosilanes such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane and 3-aminopropyltriethoxysilane. The silane coupling agent can be used at a quantity of approximately 0.05 parts by mass or higher or approximately 0.1 parts by mass or higher and approximately 2 parts by mass or lower or approximately 1 part by mass or lower relative to 100 parts by mass monofunctional monomers used to make the acrylic polymer.

Depending on the amount of any of the tackifiers, plasticizers, and additives described above, in some embodiments, the single adhesive layer may include at least 50, 60, 70, 80, 90, 95, 98, or 99 weight percent of the acrylic polymer described above in any of its embodiments.

In some embodiments, the adhesive film of the present disclosure is an optically clear adhesive. An “optically clear adhesive” refers to an adhesive having a total light transmittance of at least approximately 85% or at least approximately 90% and haze of at most approximately 5% or at most approximately 2% in the wavelength range of from 400 to 700 nm. The total light transmittance and haze are determined in accordance with JIS K 7361-1:1997 (ISO 13468-1:1996) and JIS K 7136:2000 (ISO 14782:1999), respectively. The effect of air bubbles in a solid matrix (e.g., an adhesive layer) is to reflect some light back the way it came thus reducing transmission as well as changing the direction of light that is transmitted through the bubbles thus increasing haze. An optically clear adhesive does not ordinarily contain visually observable air bubbles.

In some embodiments, the adhesive film of the present disclosure is a foamed adhesive. Foamed adhesives may be made from any of the monomers described above and include any of the additives described above. Foamed adhesives can be made, for example, by frothing a mixture of monomers optionally including a polymer prepared from the partial polymerization of the first and second monomers described above optionally in the presence of a surfactant (e.g., hydrocarbon or fluorochemical surfactant) or surface-modified nanoparticles to stabilize the foam. The gas used in the frothing process can be an inert gas (e.g., argon or nitrogen). Foamed adhesives may also include hollow microspheres (e.g., hollow ceramic (e.g., glass) microspheres or hollow polymeric microspheres such as elastomeric particles available, for example, from Akzo Nobel, Amsterdam, The Netherlands, under the trade designation “EXPANCEL”. Examples of hollow ceramic microspheres include alumina/silica microspheres having particle sizes in the range of 5 to 300 microns and a specific gravity of 0.7 (“FILLITE”, Pluess-Stauffer International), aluminum silicate microspheres having a specific gravity of from about 0.45 to about 0.7 (“Z-LIGHT”), calcium carbonate-coated polyvinylidene copolymer microspheres having a specific gravity of 0.13 (“DUALITE 6001AE”, Pierce & Stevens Corp.), and glass bubbles marketed by 3M Company, Saint Paul, Minnesota, as “3M GLASS BUBBLES” in grades K1, K15, K20, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”. Foams that include hollow microspheres are referred to as syntactic foams. Foamed adhesives can also include a hydrocarbon elastomer as described in U.S. Pat. No. 5,024,880 (Vesley et al.). Foamed adhesive may be useful, for example, for sealing, mounting, bonding, insulation, and vibration damping.

In some embodiments, the adhesive film of the present disclosure includes one or more release liners. Various release liners may be useful. In some embodiments, a release liner comprises at least one of a polyester film, polyethylene film, polypropylene film, polyolefin coated polymer film, polyolefin coated paper, acrylic coated polymer film, and polymer coated kraft paper. The polyolefin coated film or paper may be polyethylene coated film or paper. Release liners can be useful, for example, for storage, transportation, or handling of the adhesive film and when the tape is wound into a roll. In some embodiments, a release liner is coated on at least one of the major surfaces with a release coating. In some embodiments, both major surfaces of a release liner are coated with a release coating. In this case, the release coating may the same or different on each of the major surfaces of the release liner. Examples of materials useful as release coatings for release liners include acrylics, silicones, siloxanes, fluoropolymers, and urethanes. In some embodiments, a silicone coating is useful for facilitating release of the single adhesive layer.

The release liner may be produced using a variety of processing techniques. For example, liner processing techniques such as those disclosed in U.S. Pat. Appl. No. 2013/0059105 (Wright et al.) may be useful to produce a release liner suitable for practicing the present disclosure. A suitable liner processing technique may include applying a layer comprising a (meth)acrylate-functional siloxane to a major surface of a substrate and irradiating that layer in a substantially inert atmosphere comprising no greater than 500 ppm oxygen with a short wavelength polychromatic ultraviolet light source having at least one peak intensity at a wavelength of from about 160 nanometers to about 240 nanometers. Irradiating can at least partially cure the layer. In some embodiments, the layer is cured at a curing temperature greater than 25° C. The layer may be at a temperature of at least 50° C., 60° C. 70° C., 80° C., 90° C., 100° C., 125° C., or at least 150° C., in some embodiments, no more than 250° C., 225° C., 200° C., 190° C., 180° C., 170° C., 160° C., or 155° C.

FIG. 2 is a side view of an embodiment of an article 200 including the adhesive film of the present disclosure with the single adhesive layer 220 between two substrates 230, 240. In the illustrated embodiment, the first major surface 222 of the single adhesive layer 220 is adhered to a surface of the first substrate 230, and the second major surface 228 of the single adhesive layer 220 is adhered to a surface of the second substrate 240. As shown, the first major surface 222 of the single adhesive layer 220 is in direct contact with the surface of the first substrate, and the second major surface 228 of the single adhesive layer 220 is in direct contact with the surface of the second substrate. In some embodiments, the two substrates are any of the release liners described above.

The surfaces of the first substrate 230 and the second substrate 240 may be any desired material. In some embodiments, at least one of the surface of the first substrate or the surface of the second substrate comprises at least one of metal, glass, a polymer, paper, a painted surface, or a composite. The material of the surface of the first and second substrate may be found throughout the substrate, or the surface may include a different material from the bulk of the substrate. In some embodiments, the surface of the first substrate and/or second substrate comprises at least one of metal (e.g., steel, stainless steel, or aluminum), glass (e.g., which may be coated with indium tin oxide, for example), a polymer (e.g., a plastic, rubber, thermoplastic elastomer, or thermoset), paper, a painted surface, or a composite. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic); metal matrix compositions, and ceramic matrix composites. The surface of at least one of the first or second substrates may include polymers such as polyolefins (e.g., polypropylene, polyethylene, high density polyethylene, blends of polypropylene), polyamide 6 (PA6), acrylonitrile butadiene styrene (ABS), polycarbonate (PC), PC/ABS blends, polyvinyl chloride (PVC), polyamide (PA), polyurethane (PUR), thermoplastic elastomers (TPE), polyoxymethylene (POM), polystyrene, poly(methyl) methacrylate (PMMA), and combinations thereof. The surface of at least one of the first or second substrate may also include a metal coating on such polymers. In some embodiments, at least one of the first or second substrate comprises a transparent material such as glass or a polymer (e.g., acrylic or polycarbonate). The surface of the first or second substrate may be subjected to physical treatment such as corona discharge or plasma treatment or to a chemical treatment such as a primer.

The adhesive film and article of the present disclosure can be useful in a variety of applications. For example, the adhesive film can be useful for graphics attachment (e.g., branding or information graphics) and plastic assembly. Examples of useful substrate surfaces for graphics attachment include polypropylene, ABS, PC, aluminum, steel, and painted surfaces. Graphic films can be made, for example, from PUR or PVC. The adhesive film of the present disclosure can be useful for bonding dissimilar materials together. In some of these embodiments, the first substrate comprises a metal, and the second substrate comprises a rubber or plastic. In some embodiments, the first and second substrates are dissimilar plastics. The adhesive film of the present disclosure can also be useful for foam lamination in which either the first or second substrate is a foam (e.g., a polymer foam such as polyurethane, EPDM, and polyethylene foam). The adhesive film of the present disclosure can also be useful for packaging in which either the first or second substrate is a paper (e.g., polymer-coated paper) or paperboard.

In some embodiments, the first substrate is an optical film such as a surface protection film, an antireflective (AR) film, a polarizer, a phase difference plate, an optical compensation film, a brightness-improving film, a light guide, or a transparent conductive film (such as an ITO film). Examples of materials for the first substrate include polycarbonates, polyesters (for example, polyethylene terephthalate and polyethylene naphthenate), polyurethanes, poly(meth)acrylates (for example, polymethyl methacrylate), polyvinyl alcohols, polyolefins (for example, polyethylene and polypropylene), triacetyl cellulose, polymers such as cyclic olefin polymers, and substances produced from glass. The first substrate may be an optically clear substrate. An “optically clear substrate” refers to a substrate having a total light transmittance of at least approximately 85% or at least approximately 90% and haze of at most approximately 5% or at most approximately 2% within a wavelength range of from 400 to 700 nm. The total light transmittance and haze can be determined in accordance with JIS K 7361-1:1997 (ISO 13468-1:1996) and JIS K 7136:2000 (ISO 14782:1999), respectively.

The second substrate may be made from the same material as described for the first substrate or a different substrate and may be a liquid crystal display (e.g., reflective type and back light type liquid crystal display), an OLED display, a plasma display, an electroluminescence (EL) display, a touch panel or touch panel module, an electrowetting display or cathode-ray tube, electronic paper, a window, or a glazing. The display surface of the image display module can have additional layers (one layer or multiple layers) such as a light polarizing plate (which may have a surface with recesses and protrusions) for example. In some embodiments, the second substrate is an electrostatic capacitance-type touch panel, in particular, an on-cell or in-cell touch panel. When the adhesive film of the present disclosure is an optically clear adhesive, it can be useful improving the contrast of a display by reducing internal reflections which come from air gaps between the display and, for example, the cover panel or touch sensor layer.

The thicknesses of the first and second substrates described above are not particularly limited. When the substrate is a film or has a sheet shape, the thickness of the substrate may be at least approximately 50 um, at least approximately 500 um, or at least approximately 1 mm, for example, and may be up 5 mm, up to 1 mm, up to approximately 500 um, or up to approximately 100 um.

In some embodiments, the article of the present disclosure is an automotive display. The present disclosure provides an automobile including such a display. The automotive display can be, for example, a car navigation display, a Center Information Display (CID), or a Driver Information Display (DID). In such applications, the display is subjected to more severe environmental conditions than in a smartphone application. An adhesive with a relatively high modulus may be useful for withstanding the high temperatures found in automotive applications. A display may have an ink border or bezel, with a thickness of about 10 um to 60 um, for example, around the perimeter of the cover window to hide supply circuitry in the display, for example. An adhesive with a relatively lower modulus may be useful for conforming to the ink bezel, without trapping air bubbles. While a multi-layer adhesive having harder skin layers and a soft interior, laminating three adhesive layers together can be time-consuming and may require specialized equipment. Advantageously, the present disclosure provides an adhesive film having multi-layer-like properties with a single adhesive layer.

In some embodiments, the article of the present disclosure is an electronic device, in some embodiments, a mobile telephone, a personal digital assistant (PDA), a mobile game console, an electronic reading terminal, a car navigation system, a mobile music player, a clock, a television (TV), a video camera, a video player, a digital camera, a global positioning system (GPS) device, or a personal computer (PC).

The single adhesive layer useful in the adhesive film of the present disclosure may suitably have a variety of thicknesses, in some embodiments, a thickness of 0.001 inches to 0.1 inch (about 25 um to 2.54 millimeters (mm)). In some embodiments, the single adhesive layer has a thickness of 0.001 inches to 0.06 inches (about 25 um to 1.6 mm), a thickness of 0.002 inches to 0.02 inches (about 50 um to 0.508 mm) or a thickness of 0.001 inches to 0.01 inches (about 25 um to about 260 um). In some embodiments, the single adhesive layer is an optically clear adhesive having a thickness of about 0.001 inches to about 0.01 inches (about 25 um to about 260 um). In some embodiments, the single adhesive layer is a foamed adhesive having a thickness of about 0.002 inches to about 0.06 inches (about 50 um to about 1.6 mm).

The adhesive film of the present disclosure can have a wide variety of widths. Useful widths can include between 0.25 inches (0.635 cm) and 85 inches (216 cm) in width. In some embodiments, the width of the adhesive film is at least 2.5 cm. In some embodiments, the width of the adhesive film is at least 5 cm. In some embodiments, the width of the adhesive film is at most 75 cm (29.5 inches), 45 cm (17.7 inches), 30.5 cm (12 inches), or 10 cm (3.9 inches).

### Some Embodiments of the Disclosure

In a first embodiment, the present disclosure provides an adhesive film comprising:
a single adhesive layer comprising an acrylic polymer and an ultraviolet light absorber capable of absorbing in a wavelength range between 320 nanometers and 390 nanometers, the single adhesive layer having first and second opposing major surfaces and a core between the first and second opposing major surfaces,
wherein the first and second opposing major surfaces each have an elastic modulus that is higher (in any embodiments, at least 10, 15, 20, or 25 percent higher) than an elastic modulus of the core, or wherein the first and second opposing major surfaces each have an elastic modulus that is lower (in any embodiments, at least 10, 15, 20, or 25 percent lower) than an elastic modulus of the core.

In a second embodiment, the present disclosure provides the adhesive film of the first embodiment, wherein the elastic modulus of each of the first and second opposing major surfaces is higher than the elastic modulus of the core (in any embodiments, at least 10, 15, 20, or 25 percent higher).

In a third embodiment, the present disclosure provides the adhesive film of the first embodiment, wherein the elastic modulus of each of the first and second opposing major surfaces is lower than the elastic modulus of the core (in any embodiments, at least 10, 15, 20, or 25 percent lower).

In a fourth embodiment, the present disclosure provides the adhesive film of any one of the first to third embodiments, wherein the elastic modulus of the first major surface is in a range from 90 percent to 110 percent or from 80 percent to 120 percent of the elastic modulus of the opposing second major surface.

In a fifth embodiment, the present disclosure provides the adhesive film of any one of the first to fourth embodiments, wherein the single adhesive layer further comprises a photoinitiator or a fragment thereof.

In a sixth embodiment, the present disclosure provides the adhesive film of the fifth embodiment, wherein the single adhesive layer further comprises the fragment of the photoinitiator, and wherein the fragment comprises at least one of benzaldehyde, 2,4,6-trimethylbenzaldehyde, benzoic acid, 2,4,6-trimethylbenzoic acid, benzil, methyl benzoate, acetophenone, isopropanol, acetone, glycol, formaldehyde, toluene, acetaldehyde, diphenylphosphine oxide, or ethyl phenylphosphinate.

In a seventh embodiment, the present disclosure provides the adhesive film of the fifth or sixth embodiment, wherein the photoinitiator has an absorbance in a range from 400 nanometers to 500 nanometers.

In an eighth embodiment, the present disclosure provides the adhesive film of any one of the first to seventh embodiments, wherein the ultraviolet light absorber comprises at least one of an ortho-hydroxy benzophenone, an ortho-hydroxy benzotriazole, an ortho-hydroxy triazine, a cinnamate, a cyanoacrylates, a dicyano ethylene, a salicylate, an oxanilide, or a para-aminobenzoate.

In a ninth embodiment, the present disclosure provides the adhesive film of the eighth embodiment, wherein the ultraviolet light absorber comprises at least one of an ortho-hydroxy benzophenone, an ortho-hydroxy benzotriazole, or an ortho-hydroxy triazine.

In a tenth embodiment, the present disclosure provides the adhesive film of any one of the first to ninth embodiments, wherein the ultraviolet light absorber is present in the adhesive film in an amount in a range from 0.1 percent by weight to five percent by weight, based on the total weight of the adhesive film.

In an eleventh embodiment, the present disclosure provides the adhesive film of any one of the first to tenth embodiments, wherein the single adhesive layer has a thickness in a range from 25 micrometers to 1600 micrometers.

In a twelfth embodiment, the present disclosure provides the adhesive film of any one of the first to eleventh embodiments, wherein the single adhesive layer has a thickness in a range from 25 micrometers to 260 micrometers.

In a thirteenth embodiment, the present disclosure provides the adhesive film of any one of the first to twelfth embodiments, wherein the single adhesive layer is an optically clear adhesive.

In a fourteenth embodiment, the present disclosure provides the adhesive film of any one of the first to twelfth embodiments, wherein the single adhesive layer is foamed.

In a fifteenth embodiment, the present disclosure provides the adhesive film of any one of the first to fourteenth embodiments, wherein the acrylic polymer is crosslinked.

In a sixteenth embodiment, the present disclosure provides the adhesive film of any one of the first to fifteenth embodiments, wherein the acrylic polymer further comprises a pendent benzophenone group.

In a seventeenth embodiment, the present disclosure provides the adhesive film of the any one of the first to sixteenth embodiments, wherein the acrylic polymer comprises monomer units of at least one alkyl acrylate having 4 to 16, 4 to 12, 6 to 12, or 8 to 12 carbon atoms.

In an eighteenth embodiment, the present disclosure provides the adhesive film of the any one of the first to seventeenth embodiments, wherein the acrylic polymer comprises monomer units of at least one alkyl acrylate represented by formula

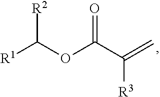

wherein R¹ and R² are each independently a C₁ to C₃₀ saturated linear alkyl group; the sum of the number of carbons in R¹ and R² is 7 to 31; and R³ is H or CH₃.

In a nineteenth embodiment, the present disclosure provides the adhesive film of any one of the first to eighteenth embodiments, wherein the acrylic polymer further comprises monomer units of at least one of acrylic acid, methacrylic acid, acrylamide, acrylonitrile, methacrylonitrile, an N-substituted acrylamide, an N,N-disubstituted acrylamide, a hydroxyalkyl acrylate, N-vinyl caprolactam, N-vinyl pyrrolidone, maleic anhydride, or itaconic acid.

In a twentieth embodiment, the present disclosure provides the adhesive film of any one of the first to nineteenth embodiments, wherein the acrylic polymer comprises monomer units of at least one of 2-ethylhexyl acrylate, 2-ethylhexyl methacrylate, 2-hydroxyethyl acrylate, or isobornyl acrylate.

In a twenty-first embodiment, the present disclosure provides an article comprising the adhesive film of any one of the first to twentieth embodiments.

In a twenty-second embodiment, the present disclosure provides the article of the twenty-first embodiment, further comprising a liquid crystal display.

In a twenty-third embodiment, the present disclosure provides the article of the twenty-first or twenty-second embodiment, wherein the article is an automobile display.

In a twenty-fourth embodiment, the present disclosure provides an automobile comprising the article of the twenty-third embodiment.

In a twenty-fifth embodiment, the present disclosure provides the article of the twenty-first or twenty-second embodiment, wherein the article is a mobile telephone, a mobile game console, an electronic reading terminal, a mobile music player, a clock, a television, a video camera, a digital camera, a global positioning system device, or a personal computer.

In a twenty-sixth embodiment, the present disclosure provides a process of making the adhesive film of any one of the first to twentieth embodiments, the process comprising:
providing a layer of a composition comprising at least one acrylic monomer and the ultraviolet light absorber capable of absorbing in the wavelength range between 320 nanometers and 390 nanometers;
irradiating both sides of the layer at the wavelength range between 320 nanometers and 390 nanometers; and
irradiating both sides of the layer at a wavelength in a range at which the ultraviolet light absorber does not absorb.

In a twenty-seventh embodiment, the present disclosure provides the process of the twenty-sixth embodiment, wherein the wavelength in a range at which the ultraviolet light absorber does not absorb is in a range from 400 nanometers to 500 nanometers.

In a twenty-eighth embodiment, the present disclosure provides the process of the twenty-sixth or twenty-seventh embodiment, wherein irradiating both sides of the layer at the wavelength range between 320 nanometers and 390 nanometers is carried out at a different light intensity than irradiating both sides of the layer at a wavelength at which the ultraviolet light absorber does not absorb.

In a twenty-ninth embodiment, the present disclosure provides the process of any one of the twenty-sixth to twenty-eighth embodiments, wherein the composition further comprises an acrylic polymer prepared from the partial polymerization of the at least one acrylic monomer.

In a thirtieth embodiment, the present disclosure provides the process of the twenty-ninth embodiment, wherein the composition comprises at least 80 percent by weight of the at least one acrylic monomer, based on the total weight of the composition.

In a thirty-first embodiment, the present disclosure provides the process of the any one of the twenty-sixth to thirtieth embodiments, wherein the at least one acrylic monomer comprises an alkyl acrylate having 4 to 16, 4 to 12, 6 to 12, or 8 to 12 carbon atoms.

In a thirty-second embodiment, the present disclosure provides the process of the any one of the twenty-sixth to thirty-first embodiments, wherein the at least one acrylic monomer comprises at least one alkyl acrylate represented by formula

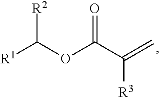

wherein R¹ and R² are each independently a C₁ to C₃₀ saturated linear alkyl group; the sum of the number of carbons in R¹ and R² is 7 to 31; and R³ is H or CH₃.

In a thirty-third embodiment, the present disclosure provides the process of any one of the twenty-sixth to thirty-second embodiments, wherein the at least one acrylic monomer comprises at least one of acrylic acid, methacrylic acid, acrylamide, acrylonitrile, methacrylonitrile, an N-substituted acrylamide, an N,N-disubstituted acrylamide, a hydroxyalkyl acrylate, N-vinyl caprolactam, N-vinyl pyrrolidone, maleic anhydride, or itaconic acid.

In a thirty-fourth embodiment, the present disclosure provides the process of any one of the twenty-sixth to thirty-third embodiments, wherein the at least one acrylic monomer comprises at least one of 2-ethylhexyl acrylate, 2-ethylhexyl methacrylate, 2-hydroxyethyl acrylate, and isobornyl acrylate.

In a thirty-fifth embodiment, the present disclosure provides the process of any one of the twenty-sixth to thirty-fourth embodiments, wherein the composition further comprises a crosslinker and a photoinitiator.

In a thirty-sixth embodiment, the present disclosure provides the process of any one of the twenty-sixth to thirty-fifth embodiments, wherein the composition is substantially solvent free.

In a thirty-seventh embodiment, the present disclosure provides the adhesive film of any one of the first to twentieth embodiments, wherein the single adhesive layer further comprises a tackifier.

In a thirty-eighth embodiment, the present disclosure provides the adhesive film of any one of the first to twentieth and thirty-seventh embodiments, further comprising a release liner on at least one of the first major surface or the second major surface.

In order that this disclosure can be more fully understood, the following examples are set forth. It should be understood that these examples are for illustrative purposes only and are not to be construed as limiting this disclosure in any manner.

### Examples

Unless otherwise noted or readily apparent from the context, all parts, percentages, ratios, etc. in the examples and the rest of the specification are by weight. The following abbreviations may be used: m=meters; cm=centimeters; mm=millimeters; um=micrometers; nm=nanometer; ft=feet; in =inch; RPM=revolutions per minute; g=grams; mg=milligrams; kg=kilograms; oz=ounces; lb=pounds; μL=microliter; mL=milliliter; L=liter; Pa=Pascals; sec=seconds; min=minutes; hr=hours; RH=relative humidity; psi=pounds per square inch; eV=electron volts; Da=Daltons; mJ/cm2=milliJoules per centimeter squared; mW/cm2=milliWatts per centimeter squared; ° C.=degrees Celsius; ° F.=degrees Fahrenheit; mol=mole; and phr=parts (by weight) per hundred of resin. The terms “weight %”, “% by weight”, and “wt %” are used interchangeably.

TABLE 1
Materials Used in the Examples

| Abbreviation | Description and Source |
|---|---|
| 2EHA | 2-ethyl hexyl acrylate, obtained from BASF Florham Park, NJ or Nihon |
| | Shokubai, Co. LTD |
| AA | Acrylic acid, obtained from BASF, Florham Park, NJ |
| 2EHMA | 2-ethylhexyl methacrylate obtained from Nitiyu, Co. Ltd |
| HEA | 2-hydroxyethyl acrylate obtained from Nihon Shokubai, Co. LTD |
| IBXA | Isobornyl acrylate obtained from Osaka Organic Chemical Industry LTD |
| HDDA | Hexanediol di-acrylate obtained from Shin-Nakamura Chemical LTD |
| PPI-One | Difunctional oligomeric alpha hydroxy ketone, Tronly New Electronic |
| | Materials CO. LTD |
| “OMNIRAD 1173” | 2-hydroxy-2-methyl-1-phenylpropanone, obtained under the trade |
| | designation “OMNIRAD 1173” from IGM Resins USA Inc. Charlotte, NC. |
| “OMNIRAD 651” | 2,2-dimethoxy-2-phenylacetophenone, obtained under the trade |
| | designation “OMNIRAD 651” from IGM Resins USA Inc. |
| “OMNIRAD 819” | Bis(2,4,6-trimethylbenzoyl)phenylphosphine oxide, obtained under the |
| | trade designation “OMNIRAD 819” from IGM Resins USA Inc. |
| “TINUVIN 329” | Tinuvin ® 329 (2 Phenol, 2-(2H-benzotriazol-2-yl)-4-(1,1,3,3- |
| | tetramethylbutyl)) BASF LTD |
| “TINUVIN 928” | Tinuvin ® 928 (2-(2H-Benzotriazol-2-yl)-6-(1-methyl-1-phenylethyl)-4- |
| | (1,1,3,3-tetramethylbutyl)phenol) BASF LTD |
| TPO | Diphenyl (2,4,6-trimethylbenzoyl)-phosphine oxide, BASF LTD |
| ABP | Acryloyloxy-benzophenone 25% by weight in IOA solution obtained from |
| | 3M Company, St. Paul, MN |

### Test Methods

### Brookfield Viscosity

Brookfield viscosity was measured with a Brookfield viscometer obtained from (Tokyo Keiki, Inc., Tokyo, Japan) at 25° C. using a No. 4 LTV spindle, at 20 revolutions per minute.

### Stainless Steel (SS) 180° Peel

Peel adhesion was measured against SS panels as test substrates. SS panels were purchased from Chem Instruments (West Chester Township, OH), part #TP-3M 2×5. The dimensions of the SS panels were 2 inches×5 inches× 3/16 inch (5.08 cm×12.7 cm×0.48 cm). Prior to any testing, the SS panels were cleaned with one methyl ethyl ketone wash, one acetone wash, and 3 washes of heptane. The adhesive was cut to 1 inch×5 inch (2.54 cm×12.7 cm) size and laminated to primed 2-mil (51-um) polyethylene terephthalate (PET) obtained from Mitsubishi Chemical Corporation, Toyko, Japan. The adhesive and PET construction was then laminated to the SS surface and rolled down with a 4.5 lb (2.0-kg) rubber roller with 4 passes at 24 inch (61-cm)/minute roller speed. The samples were then conditioned at ambient conditions (23° C.+/−2° C. and 50%+/−5% relative humidity) for 24 hours before testing. After the 24 hour dwell, a 180° peel test was performed using a IMass SP-2100 peel tester (obtained from IMASS, Inc., Accord, MA) with a force transducer obtained from Instrumentors, Inc (Strongsville, Ohio). The peel test was performed at a strain rate of 8 inch (20 cm)/minute and the peel force was averaged over 10 seconds and recorded. Two measurements were made per example and the average recorded in ounce/inch. The data can be converted to N/cm using the conversion factor 1 oz/in =0.11 N/cm.

### Rheology Measurements

An adhesive film was laminated repeatedly until the thickness reached about 2000 um. The laminated sample was cut into a circle with 8 mm diameter. The sample was loaded on DHR-3 rheometer maintained at 40° C. A shear strain of 0.1% was applied at 1 Hz frequency from −30° C. to 120° C. at 3 C/min rate. Modulus versus temperature was recorded with a DHR-3 rheometer from TA Instruments, New Castle, DE.

### Nano-Indentation Measurements

Samples were prepared by removing the easy liner and replacing it with a piece of PET. Samples were then cryo-microtomed at −60° C. without embedding. Peakforce QNM (nanomechanical mapping technique) scans were taken twice in 5 locations across the sample using an ICON AFM (obtained from Bruker Corporation, Billerica, MA) with a ScanAsyst-in-air AFM probe, and the results of the ten measurements were averaged. Three measurements of each of the first and second major surfaces were also make using the Peakforce QNM (nanomechanical mapping technique), and the results were averaged for each major surface. Calibration of the DMT modulus channel was performed using the “Relative Method”: the tip radius parameter was adjusted until the DMT modulus data matched the known sample value. A PDMS-SOFT sample provided by Bruker was used which was assigned a value near 9 MPa. The following instrument parameters were used. Scan Size=2.0 um, Aspect Ratio=1.0, X and Y offsets=0.0, Scan Angle=90°, Scan Rate=1.01 Hz, Tip Velocity=4.06 um/s, Samples/Line=512, Lines=512, Slow Scan Axis=enabled, XY Closed Loop=Digital, Feedback Gain=22.82, Peak Force Setpoint=1.006 nN, LP Detection BW=40.0 kHz, ScanAsyst Noise Threshold=0.50 nm, ScanAsyst Auto Control=individual, ScanAsyst Auto Gain=on ScanAsyst Auto Setpoint, Auto Scan Rate, and Auto Z Limit=off, Peak Force Amplitude=50.0 nm, Peak Force Frequency=2 kHz, Lift Height=32.0 nm, Sync Distance New=29.96%, Sync Distance QNM=31.99%, Use Freq Based QNM Cal=Off, Adhesion Algorithm=Absolute Minimum, Max Force Fit Boundary=100%, Min Force Fit Boundary=15%, Auto PFT Ampl. Sens=On, Spring Constant=0.3944 N/m, Tip Radius=10.0 nm, Tip Half Angle=0°, Sample Poisson's Ratio=0.500.

### Example 1 and Illustrative Examples a to C

A mixture of 2EHA/2EHMA/HEA/IBXA/“OMNIRAD 1173” (53/12/20/15/0.05) was prepared and loaded in a glass vessel. Dissolved oxygen in the mixture was removed by nitrogen gas bubbling. Subsequently, the mixture was partially polymerized by ultraviolet light irradiation through the vessel using a light source with an output centered at 365 nm for a few minutes to provide a viscous liquid, having a Brookfield viscosity of around 2000 mPa·s.

For Example 1 and Illustrative Example B, 0.3 part by mass of “OMNIRAD 819”, 0.05 part by mass of HDDA, 0.4 part by mass of “TINUVIN 329” were added in 100 parts by mass of the resulting viscous liquid. The mixture was thoroughly stirred and defoamed.

The compositions of Illustrative Examples A and C were the same as Example 1 and Illustrative Example B except they included no “TINUVIN 329”.

The resulting mixture was sandwiched by two sheets of silicone-treated polyester films (75-micrometer RF02N (SKC Hi-Tech & Marketing Co., Ltd.) and 75-micrometer RF12N (SKC Hi-Tech & Marketing Co., Ltd.), and a thickness of the mixture was adjusted to 38 um and 250 um by using a knife coater. A 38-um and 250-um thick sample was made for each example.

Example 1 and Illustrative Example A were irradiated from both sides using a light source with an output centered at 365 nm for a total dose of 120 mJ/cm² at a maximum intensity of 1.0 mW/cm². This irradiation was followed by irradiation from both sides using a light source with an output centered at 405 nm at a total dose of 1700 mJ/cm² at a maximum intensity of 30 mW/cm².

Illustrative Example B and Illustrative Example C were irradiated from both sides using a light source with an output centered at 405 nm for a total dose of 120 mJ/cm² at a maximum intensity of 1.0 mW/cm². This irradiation was followed by irradiation from both sides using a light source with an output centered at 405 nm at a total dose of 1700 mJ/cm² at a maximum intensity of 30 mW/cm².

Tan delta at 100° C. was measured for stacks of fifty-six 38-um samples and eight 250-um samples using the test method described above. The 38-um samples have a larger portion of the outer layers and when tested in a bulk modulus test provide modulus information on the outer layer. The 250-um samples have a larger portion of the core, and the modulus testing of these provides modulus information on the core. The Tan delta at 100° C. measurements for Example 1 and Illustrative Examples (Ill. Ex.) A to C are shown in Table 2, below.

TABLE 2
Tan delta at 100° C. Measurements for Example
1 and Illustrative Examples (Ill. Ex.) A to C

| | Example 1 | Ill. Ex. A | Ill. Ex. B | Ill. Ex. C |
|---|---|---|---|---|
| UV absorber pph | 0.4 | 0 | 0.4 | 0 |
| Surface Tan delta | 0.41 | 0.42 | 0.43 | 0.40 |
| Core Tan delta | 0.47 | 0.42 | 0.41 | 0.39 |
| Tan delta Difference | 0.06 | 0.0 | 0.01 | 0.02 |

### Examples 2 to 4 and Illustrative Example D

Examples 2 to 4 and Illustrative Example D were prepared as described for Example 1 and Illustrative Examples A to C with the following modifications. The parts by mass of “TINUVIN 329” added to 100 parts of the viscous liquid is shown in Table 3, below. A 38-um and 250-um thick sample was made for each Example and Illustrative Example. The samples were irradiated from both sides using a light source with an output centered at 365 nm for a total dose of 120 mJ/cm² at a maximum intensity of 1.0 mW/cm². This irradiation was followed by irradiation from both sides using a light source with an output centered at 405 nm at a total dose of 1700 mJ/cm² at a maximum intensity of 30 mW/cm². Tan delta at 100° C. was measured for stacks of fifty-six 38-um samples and eight 250-um samples using the test method described above. The results are shown in Table 3, below.

TABLE 3
Tan delta at 100° C. Measurements for Illustrative
Example (Ill. Ex.) D and Examples 2 to 4

| | Ill. Ex. D | Example 2 | Example 3 | Example 4 |
|---|---|---|---|---|
| UV absorber pph | 0 | 0.2 | 0.4 | 0.6 |
| Surface Tan delta | 0.42 | 0.39 | 0.41 | 0.40 |
| Core Tan Delta | 0.42 | 0.42 | 0.47 | 0.50 |
| Tan delta Difference | 0.00 | 0.03 | 0.06 | 0.10 |

### Examples 5 to 7

Examples 5 to 7 were prepared as described for Example 1 with the following modifications. For Examples 5 and 6, 0.12 part of ABP (25% by weight in IOA) was added to 100 parts of the viscous liquid. A 38-um and 250-um thick sample was made for each Example and Illustrative Example.

For Examples 5 and 7, the samples were irradiated from both sides using a light source with an output centered at 365 nm for a total dose of 120 mJ/cm² at a maximum intensity of 1.0 mW/cm². This irradiation was followed by irradiation from both sides using a light source with an output centered at 405 nm at a total dose of 800 mJ/cm² at a maximum intensity of 10 mW/cm². This irradiation was followed with a combination of the two light sources from both sides at a total dose of 1800 mJ/cm² at a maximum intensity of 30 mW/cm².

For Example 6, the samples were irradiated from both sides using a light source with an output centered at 365 nm for a total dose of 120 mJ/cm² at a maximum intensity of 1.0 mW/cm². This irradiation was followed by irradiation from both sides using a light source with an output centered at 405 nm at a total dose of 1700 mJ/cm² at a maximum intensity of 30 mW/cm².

Tan delta at 100° C. was measured for stacks of fifty-six 38-um samples and eight 250-um samples using the test method described above. The results are shown in Table 4, below.

TABLE 4
Tan delta at 100° C. Measurements for Examples 5 to 7

| | Example 5 | Example 6 | Example 7 |
|---|---|---|---|
| ABP pph | 0.12 | 0.12 | 0 |
| Surface Tan delta | 0.28 | 0.38 | 0.39 |
| Core Tan Delta | 0.42 | 0.47 | 0.47 |
| Tan delta Difference | 0.14 | 0.09 | 0.07 |

### Illustrative Example E and Examples 8 and 9

A mixture of 2EHA/AA/“OMNIRAD 651” (96/4/0.04) was prepared and loaded in a glass vessel. Dissolved oxygen in the mixture was removed by nitrogen gas bubbling. Subsequently, the mixture was partially polymerized by ultraviolet light irradiation through the vessel using a light source with an output centered at 365 nm for a few minutes to provide a viscous liquid, (a syrup), having a viscosity deemed suitable for coating.

Then, 0.4 part by mass of TPO, 1.0 part by mass of PPI-One, 0.4 part by mass of HDDA (25% by weight in EHA), and 1.8 part by mass of “TINUVIN 928” were added to 100 parts by mass of the resulting viscous liquid. The mixture was thoroughly stirred and defoamed.

Each of the samples were then coated in dual liner construction at approximate 38-um and 152-um thickness between two liners and irradiated using a 365 nm and 405 nm light through the liners. The liners were Loparex Grade 47636 50.0 um clear PET 7300T (Easy Release 33 g/in) and Loparex Grade 47636 50.0 um clear PET 7330T (Tight Release 58 g/in). A 38-um and 152-um thick sample was made for each Example. All samples were exposed to varying dosage levels of 365 nm and 405 nm light at a maximum intensity of 20 mW/cm².

Illustrative Example E and Examples 8 and 9 were irradiated from both sides using a light source with an output centered at 365 nm for a total dose shown in Table 5 below. This irradiation was followed with irradiation using a light source with an output centered at 405 nm from both sides at a total dose of 675 mJ/cm². The bulk modulus and peel force to stainless steel were measured for each Example and are shown in Table 5, below.

TABLE 5
Illustrative Examples E (I.E. E) and Examples 8 and 9

| | | 365 nm | tan | temp @ tan | SS Peel |
|---|---|---|---|---|---|
| Example | Thick- | Dose | delta@ | delta peak | (oz/in, |
| # | ness | (mJ/cm²) | 100° C. | (° C.) | N/cm) |
| I.E. E | 38-um | 203 | 0.5510 | −40.47 | 44.6, 4.91 |
| I.E. E | 152-um | 203 | 0.5554 | −40.97 | 73.1, 8.04 |
| 8 | 38-um | 405 | 0.7748 | −39.49 | 69.7, 7.67 |
| 8 | 152-um | 405 | 0.6526 | −40.68 | 113.7, 12.5 |
| 9 | 38-um | 608 | 0.9484 | −38.89 | 78.2, 8.60 |
| 9 | 152-um | 608 | 0.8325 | −40.42 | 119.9, 13.2 |

The increase in 365-nm light dose increases the tan delta and peel increases for 38-um samples. For 152-um samples, there is a smaller increase in tan delta and surprisingly a much larger increase in SS peel. The smaller increase in the tan delta for the thicker samples indicates that the outer surfaces have a lower modulus than the core.

### Illustrative Example F and Example 10

Illustrative Example F and Example 10 were prepared as described for Illustrative Example E and Examples 8 and 9 with the following modifications. A ratio of 2EHA/AA 88:12 was used instead of 96:4. ABP (250% by weight in IOA) (2 parts) was added to 100 parts of the viscous liquid, and no PPI-One was used. Films that were 6 mils (152-um) were prepared.

For Illustrative Example F, the sample was irradiated from both sides using a light source with an output centered at 405 nm for a total dose of 1080 mJ/cm² at a maximum intensity of 10 mW/cm².

For Example 10, the sample was irradiated from both sides using a light source with an output centered at 405 nm for a total dose of 675 mJ/cm² at a maximum intensity of 10 mW/cm². This irradiation was followed by irradiation from both sides using a light source with an output centered at 365 nm at a total dose of 608 mJ/cm² at a maximum intensity of 10 mW/cm².

The opposing major surfaces of Illustrative Example F and Example 10 were measured using Atomic Force Microscopy using the method described above. For Illustrative Example F, the surface made adjacent Loparex Grade 47636 50.0 um clear PET 7330T (Tight Release 58 g/in) was measured to have a DMT Modulus of 97.2 MPa, with a standard deviation of 2.3, and the surface made adjacent Loparex Grade 47636 50.0 um clear PET 7300T (Easy Release 33 g/in) was measured to have a DMT Modulus of 106 MPa, with a standard deviation of 6.2. The core was measured to have a DMT Modulus of 103.6 MPa, with a standard deviation over the cross-section of 5.3.

For Example 10, the surface made adjacent Loparex Grade 47636 50.0 um clear PET 7330T (Tight Release 58 g/in) was measured to have a DMT Modulus of 164.4 MPa, with a standard deviation of 14.0, and the surface made adjacent Loparex Grade 47636 50.0 um clear PET 7300T (Easy Release 33 g/in) was measured to have a DMT Modulus of 164.5 MPa, with a standard deviation of 3.9. The core was measured to have a DMT Modulus of 141.7 MPa, with a standard deviation of 4.9.

This disclosure may take on various modifications and alterations without departing from its spirit and scope. Accordingly, this disclosure is not limited to the above-described embodiments but is to be controlled by the limitations set forth in the following claims and any equivalents thereof. This disclosure may be suitably practiced in the absence of any element not specifically disclosed herein.

1. An adhesive film comprising:
a single adhesive layer comprising an acrylic polymer and an ultraviolet light absorber capable of absorbing in a wavelength range between 320 nanometers and 390 nanometers, the single adhesive layer having first and second opposing major surfaces and a core between the first and second opposing major surfaces,
wherein the first and second opposing major surfaces each have an elastic modulus that is higher than an elastic modulus of the core, or wherein the first and second opposing major surfaces each have an elastic modulus that is lower than an elastic modulus of the core.

2. The adhesive film of claim 1, wherein the elastic modulus of each of the first and second opposing major surfaces is higher than the elastic modulus of the core.

3. The adhesive film of claim 1, wherein the elastic modulus of each of the first and second opposing major surfaces is lower than the elastic modulus of the core.

4. The adhesive film of claim 1, wherein the elastic modulus of the first major surface is in a range from 90 percent to 110 percent of the elastic modulus of the opposing second major surface.

5. The adhesive film of claim 1, wherein the single adhesive layer further comprises at least one photoinitiator or a fragment thereof.

6. The adhesive film of claim 5, wherein the single adhesive layer further comprises the fragment of the at least one photoinitiator, and wherein the fragment comprises at least one of benzaldehyde, 2,4,6-trimethylbenzaldehyde, benzoic acid, 2,4,6-trimethylbenzoic acid, benzil, methyl benzoate, acetophenone, isopropanol, acetone, glycol, formaldehyde, toluene, acetaldehyde, diphenylphosphine oxide, or ethyl phenylphosphinate.

7. The adhesive film of claim 5, wherein the at least one photoinitiator has an absorbance in a range from 400 nanometers to 500 nanometers.

8. The adhesive film of claim 1, wherein the ultraviolet light absorber comprises at least one of an ortho-hydroxy benzophenone, an ortho-hydroxy benzotriazole, an ortho-hydroxy triazine, a cinnamate, a cyanoacrylates, a dicyano ethylene, a salicylate, an oxanilide, or a para-aminobenzoate.

9. The adhesive film of claim 1, wherein the ultraviolet light absorber is present in the adhesive film in an amount in a range from 0.1 percent by weight to five percent by weight, based on the total weight of the adhesive film.

10. The adhesive film of claim 1, wherein the single adhesive layer has a thickness in a range from 25 micrometers to 1600 micrometers.

11. The adhesive film of claim 1, wherein the single adhesive layer is an optically clear adhesive.

12. The adhesive film of claim 1, wherein the single adhesive layer is foamed.

13. The adhesive film of claim 1, wherein the acrylic polymer is crosslinked.

14. The adhesive film of claim 1, wherein the acrylic polymer further comprises a pendent benzophenone group.

15. An automotive display comprising the adhesive film of claim 1.

16. The adhesive film of claim 1, wherein the single adhesive layer has a thickness in a range from 25 micrometers to 260 micrometers.

17. The adhesive film of claim 1, wherein the acrylic polymer comprises monomer units of at least one alkyl acrylate having 4 to 16 carbon atoms.

18. The adhesive film of claim 1, wherein the acrylic polymer comprises monomer units of at least one of 2-ethylhexyl acrylate, 2-ethylhexyl methacrylate, 2-hydroxyethyl acrylate, or isobornyl acrylate.

19. The adhesive film of claim 1, wherein the acrylic polymer further comprises monomer units of at least one of acrylic acid, methacrylic acid, acrylamide, acrylonitrile, methacrylonitrile, an N-substituted acrylamide, an N,N-disubstituted acrylamide, a hydroxyalkyl acrylate, N-vinyl caprolactam, N-vinyl pyrrolidone, maleic anhydride, or itaconic acid.

20. An article comprising the adhesive film of claim 1, wherein the article is a mobile telephone, a mobile game console, an electronic reading terminal, a mobile music player, a clock, a television, a video camera, a digital camera, a global positioning system device, or a personal computer.
